(19) United States
(12) Patent Application Publication
(10) Pub. No.: US 2010/0124154 A1
(43) Pub. Date: May 20, 2010

(54) SIGNAL PROCESSING DEVICES AND SIGNAL PROCESSING METHODS

(76) Inventors: Chih-Ching Yu, Hsinchu City (TW); Yu-Hsuan Lin, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/510,258

(22) Filed: Jul. 27, 2009

Related U.S. Application Data
(60) Provisional application No. 61/115,963, filed on Nov. 19, 2008.

(51) Int. Cl. G11B 7/00

(52) U.S. Cl. 369/53.12; G9B/7

(57) ABSTRACT

A signal processing device includes a processing circuit and a signal generating circuit. The processing circuit is implemented for determining a position of at least one defective area on an optical storage medium according to a defect signal, and accordingly recording defect position information of the at least one defective area. The signal generating circuit is coupled to the processing circuit, and implemented for generating an output signal according to at least the recorded defect position information of the at least one defective area.

### CROSS REFERENCE TO RELATED APPLICATIONS

This application claims the benefit of U.S. Provisional Application No. 61/115,963, filed on Nov. 19, 2008 and incorporated herein by reference.

### BACKGROUND

The present invention relates to reading information from an optical storage medium, and more particularly, to signal processing devices and related signal processing methods for dealing with a defect signal associated with defective areas on an optical storage medium (e.g., an optical disc).

Optical storage media, such as read-only, recordable, or rewritable optical discs, have become popular data carriers nowadays. In general, the stored data are reproduced from reading a recording layer (i.e., a reflective layer) of an optical storage medium through directing a laser beam with a proper power onto the recording layer and then detecting signals reflected from the recording layer. To protect the recording layer, a protective layer made of, for example, polycarbonate is generally formed on the recording layer. Therefore, the laser beam emitted from a laser diode has to pass through the protective layer before arriving at the recording layer; similarly, the laser beam reflected from the recording layer has to pass through the protective layer before being detected by an optical pickup head. Therefore, the signal quality of the reflected laser beam detected by the optical pickup head is actually affected by the protective layer. However, the optical storage medium, such as an optical disc, might have defective areas due to scratch, dirt, or fingerprint on a surface of the protective layer.

Regarding the current high-density optical disc drive (e.g., a Blu-ray disc drive), it is more difficult to do the servo control due to smaller track pitch. Particularly, when there are defective areas on an optical disc, the servo control mechanism, including a focus control loop and a tracking control loop, usually applies inappropriate servo control effort around the beginning position and end position of each defective area, which degrades the data reading performance of the optical disc greatly. FIG. 1 is a waveform diagram of a defect signal S1, a servo output signal (e.g., a tracking servo output TRO or focus servo output FOO) S2, and a radio-frequency (RF) signal S3 which are generated when an optical pickup head of an optical disc drive accesses an optical disc with a defective area formed thereon. In a conventional optical disc drive, a protection means is employed to hold the servo control setting when the defect signal S1 indicates that the optical pickup head is accessing the defective area. In general, the defect signal S1 is generated to detect defective areas on the optical disc in a real-time manner, and has a transition from a first logic level (e.g., ‘0’) to a second logic level (e.g., ‘1’) to indicate the beginning point of a detected defective area, and another transition from the second logic level (e.g., ‘1’) to the first logic level (e.g., ‘0’) to indicate the end point of the detected defective area in an ideal case. However, there may be a delay between the timing when the defect signal S1 has a rising edge (i.e., a transition from the first logic level to the second logic level to indicate the beginning point of a defective area) and the timing when the optical pickup head is located at the actual beginning point of the defective area. Due to different reflection characteristics between a normal area and a defective area on the optical disc, the servo control mechanism, as one can see, applies a first servo control effort FOO1/TRO1 before the defect signal S1 has a rising edge at time T1, and applies a second servo control effort FOO2/TRO2 after the defect signal S1 has a falling edge at time T2. As one can see, when the transition of the defect signal S1 for indicating the beginning point of a detected defective area is generated too late, the amount of the first servo control effort FOO1/TRO1 would become larger to seriously shift the focus point/tracking point of the laser beam from a correct position. As a result, when the optical pickup head leaves the defective area, the second servo control effort FOO2/TRO2 would be larger to make the erroneously shifted focus point/tracking point moved to the correct position, which causes serious distortion in the RF signal S3 and might result in reading failure of the normal area immediately following the defective area.

Therefore, how to avoid or mitigate the signal quality degradation caused by applying inappropriate servo control effort due to defective areas formed on the optical disc becomes an important issue to be resolved.

### SUMMARY OF THE INVENTION

In accordance with embodiments of the present invention, exemplary signal processing devices and signal processing methods for dealing with a defect signal associated with defective areas on an optical storage medium (e.g., an optical disc) are proposed.

According to a first aspect of the present invention, a signal processing device is provided. The signal processing device includes a processing circuit and a signal generating circuit. The processing circuit is for determining a position of at least one defective area on an optical storage medium according to a defect signal, and accordingly recording defect position information of the at least one defect. The signal generating circuit is coupled to the processing circuit, and implemented for generating an output signal according to at least the recorded defect position information of the at least one defective area.

According to a second aspect of the present invention, a signal processing device is provided. The signal processing device includes a processing circuit and a signal generating circuit. The processing circuit is implemented for recording defect information of at least one defective area on an optical storage medium according to a defect signal derived during a first full rotation of the optical storage medium. The signal generating circuit is coupled to the processing circuit, and implemented for generating an adjusted defect signal by adjusting the defect signal derived during a second full rotation of the optical storage medium, which follows the first full rotation of the optical storage medium, according to the recorded defect information of the at least one defective area.

According to a third aspect of the present invention, a signal processing device is provided. The signal processing device includes a processing circuit and a signal generating circuit. The processing circuit is implemented for detecting a starting point of a signal portion, which is indicative of a corresponding defective area on an optical storage medium and included in a defect signal, and when the starting point of the signal portion is detected, estimating an amount of latest servo control effort applied before the starting point of the signal portion. The signal generating circuit is coupled to the processing circuit, and implemented for controlling a servo control circuit to compensate for the amount of latest servo control effort applied before the starting point of the signal portion.

According to a fourth aspect of the present invention, a signal processing method is provided. The signal processing method includes: determining a position of at least one defective area on an optical storage medium according to a defect signal; recording defect position information of the at least one defective area; and generating an output signal according to at least the recorded defect position information of the at least one defective area.

According to a fifth aspect of the present invention, a signal processing method is provided. The signal processing method includes: recording defect information of at least one defective area on an optical storage medium according to a defect signal derived during a first full rotation of the optical storage medium; and generating an adjusted defect signal by adjusting the defect signal derived during a second full rotation of the optical storage medium, which follows the first full rotation of the optical storage medium, according to the recorded defect information of the at least one defective area.

According to a sixth aspect of the present invention, a signal processing method is provided. The signal processing method includes: detecting a starting point of a signal portion, which is indicative of a corresponding defective area on an optical storage medium and included in a defect signal, and when the starting point of the signal portion is detected, estimating an amount of latest servo control effort applied before the starting point of the signal portion; and controlling a servo control circuit to compensate for the amount of latest servo control effort applied before the starting point of the signal portion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a waveform diagram of a defect signal, a servo output signal and a radio-frequency signal which are generated when an optical pickup head of an optical disc drive accesses an optical disc with a defective area formed thereon.

FIG. 2 is a block diagram of a generalized signal processing device according to an exemplary embodiment of the present invention.

FIG. 3 is a block diagram illustrating one detailed implementation of the signal processing device shown in FIG. 2.

FIG. 4 is a waveform diagram of a defect signal derived during a first full rotation of an optical storage medium, a defect signal derived during a second full rotation of the optical storage medium, a specific signal, and an adjusted defect signal.

FIG. 5 is a diagram illustrating the relation between the position on an optical storage medium and a counter value generated by a counter shown in FIG. 3.

FIG. 6 is a block diagram illustrating an optical disc drive with the signal processing device shown in FIG. 3.

FIG. 7 is a block diagram illustrating an optical disc drive with a feedforward control mechanism implemented therein.

FIG. 8 is a waveform diagram of a defect signal and a servo output signal (e.g., a tracking servo output or focus servo output).

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

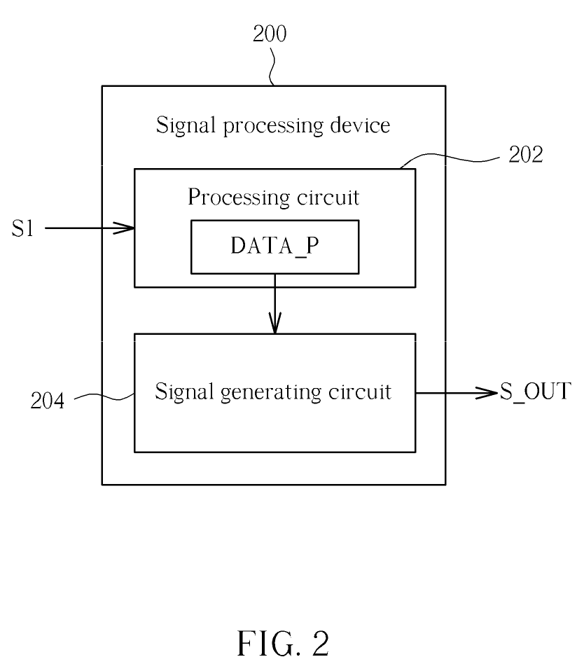

FIG. 2 is a block diagram of a generalized signal processing device according to an exemplary embodiment of the present invention. The signal processing device 200 includes, but is not limited to, a processing circuit 202 and a signal generating circuit 204. The processing circuit 202 is implemented for determining a position of at least one defective area on an optical storage medium (e.g., an optical disc) according to a defect signal S1, and accordingly recording defect position information DATA_P of the at least one defective area. The signal generating circuit 204 is coupled to the processing circuit 202, and implemented for generating an output signal S_OUT according to at least the recorded defect position information DATA_P of the at least one defective area. As a frequency generator (FG) signal generated in response to a spindle rotation has a predetermined number of FG pulses per one full rotation of the optical storage medium, address information can be obtained from a wobble signal derived from a wobble track on the optical storage medium or a data signal (e.g., eight-to-fourteen modulation data) derived from a data track on the optical storage medium, and a clock signal with a predetermined clock frequency can be employed to count an absolute time elapsed after an optical storage apparatus starts rotating the optical storage medium, the processing circuit 202 therefore can obtain absolute positions of defective areas found in each full rotation of the optical storage medium through referring to the frequency generator (FG) signal, the wobble signal, the data signal, or the absolute time.

By way of example, not a limitation, the output signal S_OUT in one exemplary implementation can be used to serve as a servo protection signal for preventing the servo control mechanism from applying inappropriate servo control effort before an optical pickup head enters the defective area on the optical storage medium. For example, the signal generating circuit 204 generates the output signal S_OUT by adjusting the original defect signal S1 according to the recorded defect position information DATA_P obtained by the processing circuit 202. However, it should be noted that using the output signal S_OUT to act as a servo protection signal is for illustrative purposes only. Any application using a signal generated according to recorded defect position information DATA_P of defective area(s) on an optical storage medium falls within the scope of the present invention.

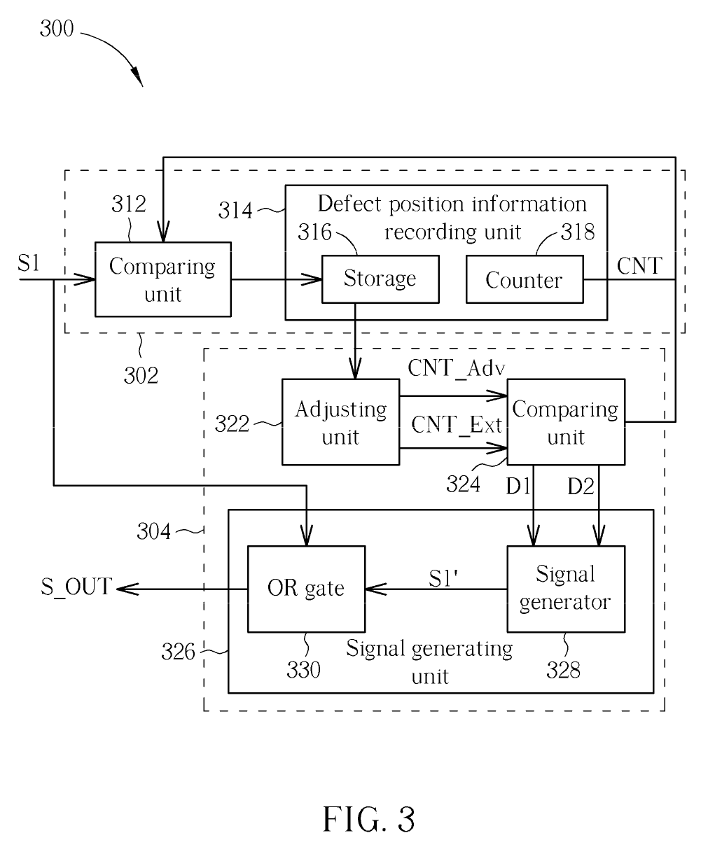

Please refer to FIG. 3, which is a block diagram illustrating one exemplary implementation of the signal processing device shown in FIG. 2. In this exemplary implementation, the signal processing device 300 includes a processing circuit 302 configured for recording defect information of at least one defective area on an optical storage medium (e.g., an optical disc) according to a defect signal S1 derived during a first full rotation of the optical storage medium, and a signal generating circuit 304 configured for generating an adjusted defect signal (i.e., an output signal S_OUT) by adjusting the defect signal S1 derived during a second full rotation of the optical storage medium, which follows the first full rotation of the optical storage medium, according to the recorded defect information of the at least one defective area. More specifically, the processing circuit 302 in this exemplary implementation determines a position of the at least one defective area on the optical storage medium according to the defect signal S1 derived during the first full rotation of the optical storage medium, and then records defect position information of the at least one defective area as the defect information of the at least one defective area. The defect position information will be referenced for adjusting the defect signal S1 derived during the following second full rotation of the optical storage medium. In this exemplary implementation, the signal generating circuit 304 generates the adjusted defect signal (i.e., the output signal S_OUT) by advancing a starting point of a signal portion, which is indicative of a corresponding defective area on the optical storage medium and included in the defect signal S1 derived during the second full rotation of the optical storage medium, according to the recorded defect information of the at least one defective area. Further description directed to operations of the signal processing device 300 shown in FIG. 3 is detailed as follows.

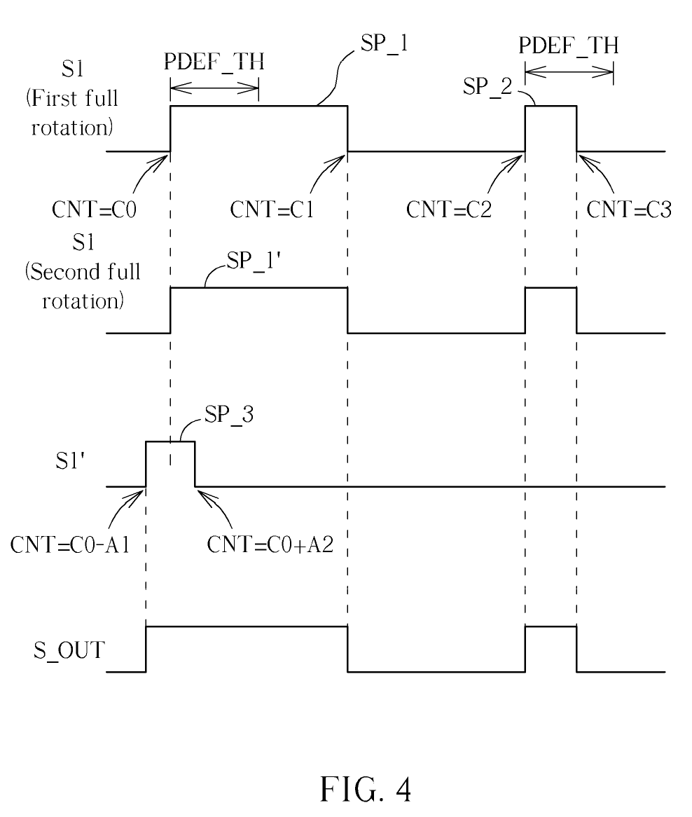

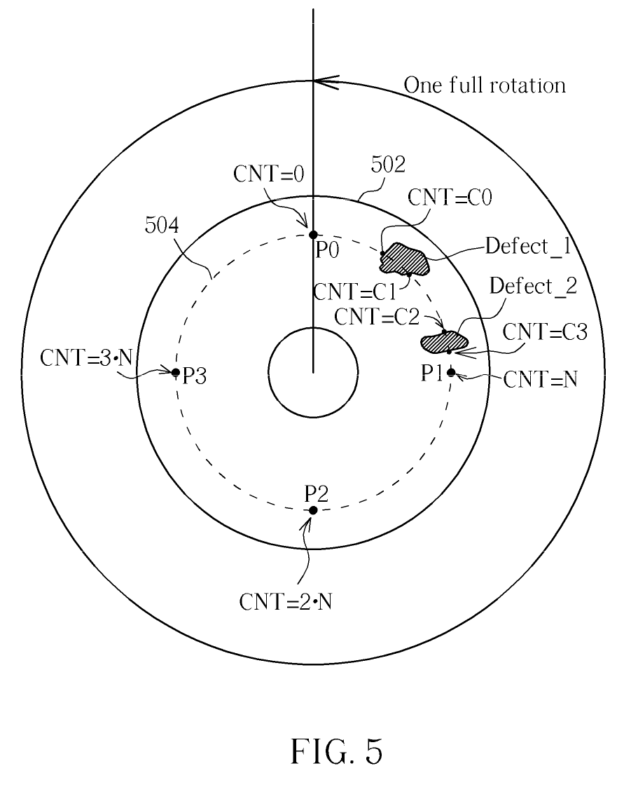

Please refer to FIG. 3 in conjunction with FIG. 4 and FIG. 5. FIG. 4 is a waveform diagram of the defect signal S1 derived during the first full rotation of the optical storage medium, the defect signal S1 derived during the second full rotation of the optical storage medium, a specific signal S1′, and the adjusted defect signal (i.e., the output signal S_OUT). FIG. 5 is a diagram illustrating the relation between the position on the optical storage medium 502 and the counter value CNT generated by the counter 318. As shown in FIG. 3, the processing circuit 302 includes a comparing unit 312 and a defect position information recording unit 314. The comparing unit 312 is coupled to the defect position information recording unit 314, and implemented for comparing a width of a specific signal portion included in the defect signal S1 with a predetermined threshold value PDEF_TH, where the specific signal portion is indicative of a corresponding defective area on the optical storage medium. With regard to the defect position information recording unit 314, when the comparing unit 312 detects that the width of the specific signal portion substantially reaches the predetermined threshold value PDEF_TH, the defect position information recording unit 314 records defect position information of the corresponding defective area according to a position of the corresponding defective area on the optical storage medium. In this exemplary implementation, the operations of the comparing unit 312 and the defect position information recording unit 314 are simply based on a counter output which is derived from counting, for example, FG pulses included in an FG signal generated in response to a spindle rotation. As shown in FIG. 3, the defect position information recording unit 314 includes a storage 316 and a counter 318. As the FG signal has a predetermined number of FG pulses per one full rotation of the optical storage medium, the counter 318 in this exemplary embodiment may be configured to count the FG pulses to achieve the objective of counting each full rotation of the optical storage medium to generate a counter value CNT indicative of a corresponding position on the optical storage medium where the optical pickup head is located. However, it should be noted that counting the FG pulses merely serves as one possible implementation, and is not meant to be taken as a limitation to the scope of the present invention. Any implementation using a counter to generate a counter value for indicating a position on the optical storage medium during one full rotation of the optical storage medium obeys the spirit of the present invention.

The storage 316 records the defect position information of a defective area by storing the counter value CNT corresponding to the defective area. Please refer to FIG. 5, which is a diagram illustrating the relation between the position on the optical storage medium 502 and the counter value CNT generated by the counter 318. In one full rotation of the optical storage medium 502, the counter 318 is reset to an initial value (e.g., 0) to the counter value CNT, and then increases the counter value CNT gradually. Please note that the counter 318 would be reset after each full rotation of the optical storage medium 502. Assume that the optical storage medium 502 is rotated in a counter-clockwise direction. Therefore, the optical pickup head moves alone the track 504 on the optical storage medium 502 in a clockwise direction. Provided that each full rotation of the optical storage medium 502 begins at the same absolute position determined according to the FG signal generated in response to the spindle rotation, the counter 318 is reset (CNT=0) when the optical pickup head is located at the position P0 of the track 504, the counter 318 has the counter value CNT equal to N when the optical pickup head is located at the position P1 of the track 504, the counter 318 has the counter value CNT equal to 2*N when the optical pickup head is located at the position P2 of the track 504, and the counter 318 has the counter value CNT equal to 3*N when the optical pickup head is located at the position P3 of the track 504.

As can be seen from FIG. 5, there are two defective areas Defect_1 and Defect_2 on the optical storage medium 502. When the optical pickup head reads the track 504 during a first full rotation of the optical storage medium 502, the optical pickup head enters the defective area Defect_1 and the defective area Defect_2 in order. Therefore, as shown in FIG. 4, the defect signal S1 generated by any conventional means has one signal portion SP_1, which is indicative of the corresponding defective area Defect_1 on the optical storage medium 502 and included in the defect signal S1 derived during the first full rotation of the optical storage medium 502, and another signal portion SP_2, which is indicative of the corresponding defective area Defect_2 on the optical storage medium 502 and included in the defect signal S1 derived during the first full rotation of the optical storage medium 502. The rising edge of the signal portion SP_1 corresponds to a start point of the defective area Defect_1 along the track 504 where the optical pickup head moves, and the falling edge of the signal portion SP_1 corresponds to an end point of the defective area Defect_1 along the track 504 where the optical pickup head moves. The counter value CNT corresponding to the rising edge of the signal portion SP_1 is denoted by C0, and the counter value CNT corresponding to the falling edge of the signal portion SP_1 is denoted by C1 (C1>C0). The comparing unit 312 can easily determine whether the width of the signal portion SP_1 substantially reaches the predetermined threshold value PDEF_TH by the counter values C0 and C1. For example, the comparing unit 312 calculates a difference value between the counter values C0 and C1, and then compares the difference value (i.e., C1−C0) with the predetermined threshold value PDEF_TH. As the difference value (C1−C0) exceeds the predetermined threshold value PDEF_TH, the defect position information recording unit 314 records defect position information of the corresponding defective area Defect_1 according to a position of the corresponding defective area Defect_1 on the optical storage medium 502. For example, the counter value C0 indicative of the position of the corresponding defective area Defect_1 on the optical storage medium 502 is stored into the storage 316.

Regarding the other defective area Defect_2 on the optical storage medium 502, the counter value CNT corresponding to the rising edge of the signal portion SP_2 is denoted by C2, and the counter value CNT corresponding to the falling edge of the signal portion SP_2 is denoted by C3. Similarly, the comparing unit 312 calculates a difference value between the counter values C3 and C2, and then compares the difference value (i.e., C3−C2) with the predetermined threshold value PDEF_TH. As the difference value (C3−C2) is smaller than the predetermined threshold value PDEF_TH, the defect position information recording unit 314 does not record defect position information of the corresponding defective area Defect_2. In other words, the counter value C3 indicative of the position of the corresponding defective area Defect_2 on the optical storage medium 502 is not stored into the storage 316.

Due to product cost consideration, the storage 316 implemented for recording defect position information of defective area(s) generally has a limited capacity. Therefore, the comparing unit 312 is used to identify any defective area with a significant effect upon the track where the optical pickup head is accessing, and only the counter value corresponding to the qualified defective area is allowed to be recorded in the storage 316. In this way, the comparing unit 312 stores counter values each corresponding to a rising edge of a specific defect signal portion with a signal width substantially reaching the predetermined threshold value PDEF_TH into the storage 316 until the storage space allocated in the storage 316 for recording counter values during one full rotation of the optical storage medium is full or one full rotation of the optical storage medium is completed. However, the comparing unit 312 can be omitted in an alternative design. Therefore, counter values each corresponding to a corresponding defective area are successively stored into the storage 316 until the storage space allocated in the storage 316 for recording counter values during one full rotation of the optical storage medium is full or one full rotation of the optical storage medium is completed. This also falls within the scope of the present invention.

The counter values stored in the storage 316 will be referenced by the signal generating circuit 304 for generating the output signal S_OUT. As shown in FIG. 3, the signal generating circuit 304 includes an adjusting unit 322, a comparing unit 324, and a signal generating unit 326, where the signal generating unit 326 has a signal generator 328 and an OR gate 330. The adjusting unit 322 is implemented for adjusting each stored counter value corresponding to a specific defective area (e.g., the counter value C0 corresponding to the defective area Defect_1) by a first adjustment value A1 and a second adjustment value A2. In this way, a first adjusted counter value CNT_Adv and a second adjusted counter value CNT_Ext are generated, respectively. The comparing unit 324 is coupled to the counter 318 and the adjusting unit 322, and implemented for comparing the counter value CNT currently counted by the counter 318 with the first adjusted counter value CNT_Adv and the second adjusted counter value CNT_Ext. For example, when the counter value CNT currently counted by the counter 318 is equal to the first adjusted counter value CNT_Adv, the comparing unit 324 generates a first indication signal D1 to notify the signal generating unit 326, and when the counter value CNT currently counted by the counter 318 is equal to the second adjusted counter value CNT_Ext, the comparing unit 324 generates a second indication signal D2 to notify the signal generating unit 326. The signal generating unit 326 is coupled to the comparing unit 324, and implemented for generating a specific signal S1′ which has a level transition when the counter value CNT currently counted by the counter 318 substantially reaches either of the first adjusted counter value CNT_Adv and the second adjusted counter value CNT_Ext, and outputting the output signal S_OUT according to at least the specific signal S1′. More specifically, the signal generating unit 326 makes the generated specific signal S1′ have a level transition when notified by either of the first indication signal D1 and the second indication signal D2.

In this exemplary implementation, the adjusting unit 322 subtracts the first adjustment value Al from the stored counter value corresponding to a defective area to generate the first adjusted counter value CNT_Adv, and adds the second adjustment value A2 to the stored counter value corresponding to the defective area to generate the second adjusted counter value CNT_Ext. Taking the aforementioned counter value C0 recorded in the storage 316 during the first full rotation of the optical storage medium 502 for example, the corresponding first adjusted counter value CNT_Adv would be set by C0−A1, and the corresponding second adjusted counter value CNT_Ext would be set by C0+A2 during the second full rotation of the optical storage medium 502. The comparing unit 324 therefore compares the counter value CNT currently counted by the counter 318 during the second full rotation of the optical storage medium 502 with the first adjusted counter value CNT_Adv (i.e., C0−A1) and the second adjusted counter value CNT_Ext (i.e., C0+A2), respectively. The signal generator 328 in the signal generating unit 326 makes the specific signal S1′ have a level transition from a first logic level (e.g., ‘0’) to a second logic level (e.g., ‘1’) when the first indication signal D1 indicates that the counter value CNT currently counted by the counter 318 substantially reaches the first adjusted counter value CNT_Adv, and makes the specific signal S1′ have a level transition from the second logic level (e.g., ‘1’) to the first logic level (e.g., ‘0’) when the second indication signal D2 indicates that the counter value CNT currently counted by the counter 318 substantially reaches the second adjusted counter value CNT_Ext. The exemplary specific signal S1′ generated from the signal generator 328 is shown in FIG. 4. A signal portion SP_3 with a high logic level is generated in the specific signal S1′.

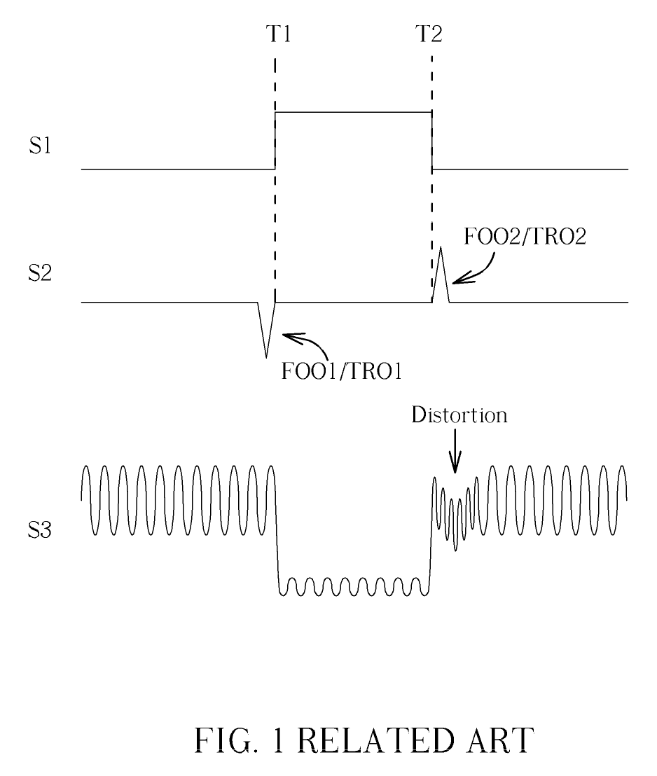

The OR gate 330 in the signal generating unit 326 generates the output signal S_OUT by performing an OR logic operation upon the specific signal S1′ and the defect signal S1. The output signal S_OUT therefore can be used to replace the defect signal S1 which may act as a servo protection signal referenced to prevent the servo control mechanism from applying inappropriate servo control effort when the optical pickup head enters a defective area on an optical storage medium. That is, the output signal S_OUT can act as an adjusted defect signal in such an exemplary implementation. As can be seen from FIG. 4, the signal generating circuit 326 generates the adjusted defect signal (i.e., the output signal S_OUT) by advancing a starting point of a signal portion SP_1′, which is indicative of a corresponding defective area on the optical storage medium and included in the defect signal S1 derived during the second full rotation of the optical storage medium, by the first adjustment value A1. In other words, when the output signal S_OUT is employed to act as a servo protection signal, the servo protection applied to the servo control mechanism for holding the servo control settings is enabled in advance, which effectively blocks the servo control mechanism from applying the aforementioned inappropriate servo control effect (e.g., FOO1/TRO1 shown in FIG. 1). In this way, the servo control effort can be controlled appropriately before the starting point of a defective area (i.e., before the optical pickup head starts entering the defective area). Thus, the actual focus point and/or tracking point of the laser beam emitted from the optical pickup head would not be seriously shifted from the correct position at the end point of the defective area (i.e., when the optical pickup head just leaves the defective area). As the signal distortion of the RF signal, as shown in FIG. 1, can be avoided or alleviated, data reading performance of the normal area immediately following the defective area can be enhanced greatly.

In above exemplary implementation, the output signal S_OUT is generated by the OR gate 330 according to the specific signal S1′ generated in response to the count value (e.g., C0) recorded during the first full rotation of the optical storage medium and the defect signal S1 derived during the second full rotation of the optical storage medium. As the track pitch is quite small for a high-density optical disc drive (e.g., a Blu-ray disc drive), the waveform of the defect signal S1 derived during the second full rotation of the optical storage medium is almost identical to that of the defect signal S1 derived during the first full rotation of the optical storage medium. However, it is possible that the rising edge of the signal portion SP_1′ is not aligned with that of the signal portion SP_1 due to certain factors, such as unstable spindle rotation. In a case where the rising edge of the signal portion SP_1′ lags behind that of the signal portion SP_1, and the signal generator 328 is configured to make the specific signal S1′ have a level transition from the second logic level (e.g., ‘1’) to the first logic level (e.g., ‘0’) when the counter value CNT currently counted by the counter 318 substantially reaches the stored counter value (e.g., C0), the falling edge of the signal portion SP_3 would lead the rising edge of the signal portion SP_1′. As a result, due to the OR logic operation performed by the OR gate 330, the resultant output signal S_OUT will not have a consistent high logic level during an interval between the falling edge of the signal portion SP_3 and the rising edge of the signal portion SP_1′. If the output signal S_OUT is used to serve as the aforementioned servo protection signal, the servo protection is erroneously disabled in a short period within an interval between the falling edge of the signal portion SP_3 and the rising edge of the signal portion SP_1′. To avoid such a problem, the second adjusted counter value CNT_Ext is preferably set to guarantee that the falling edge of the signal portion SP_3 falls behind the rising edge of the signal portion SP_1′. However, if the output signal S_OUT is used by a specific application rather than the aforementioned servo protection or the above-mentioned problem is not significant under certain operational conditions, the hardware associated with the second adjusted counter value CNT_Ext may be omitted. That is, in an alternative design, the signal generator 328 is implemented to make the specific signal S1′ have a level transition from the first logic level (e.g., ‘0’) to the second logic level (e.g., ‘1’) when the counter value CNT currently counted by the counter 318 substantially reaches the first adjusted counter value CNT_Adv, and then make the specific signal S1′ have a level transition from the second logic level (e.g., ‘1’) to the first logic level (e.g., ‘0’) when the counter value CNT currently counted by the counter 318 substantially reaches the stored counter value (e.g., C0). This also falls within the scope of the present invention.

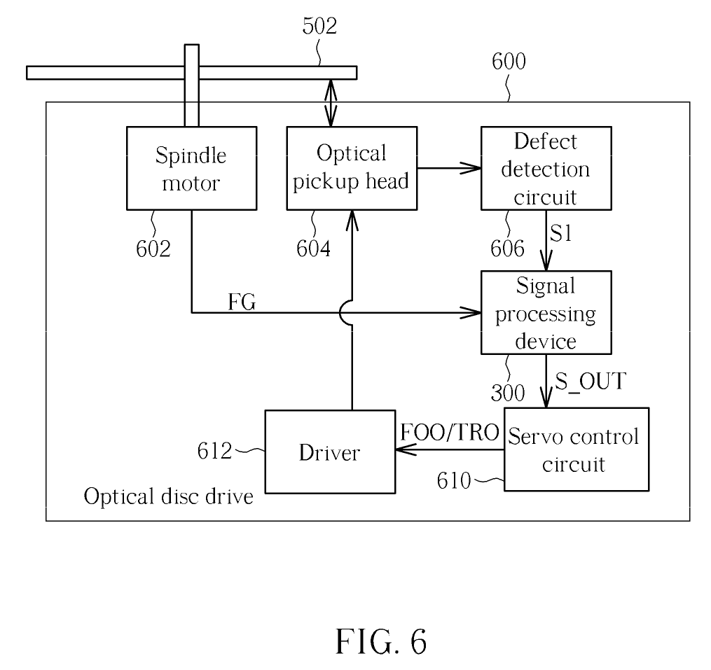

The signal processing device 300 can be disposed in an optical disc drive to provide the output signal S_OUT acting as the servo protection signal referenced to prevent the servo control mechanism from applying inappropriate servo control effort due to defective areas on the optical storage medium. For clarity, please refer to FIG. 6, which shows an optical disc drive 600 having the signal processing device 300 implemented therein. The optical disc drive 600 includes, but is not limited to, a spindle motor 602, an optical pickup head 604, a defect detection circuit 606, the signal processing device 300, a servo control circuit 610, and a driver 612. The spindle motor 602 is for rotating the optical storage medium (e.g., an optical disc) 502 at a target rotational speed, where a frequency generator signal FG is generated in response to the spindle rotation of the spindle motor 602. The optical pickup head 604 is for emitting a laser beam to access the optical storage medium 502. The defect detection circuit 606 is for generating the defect signal S1 according to signals generated from the optical pickup head 604; however, this is for illustrative purposes only. Actually, the defect signal S1 fed into the signal processing device 300 can be derived by any conventional means. As the present invention does not focus on the defect detection, further description directed to generating the defect signal S1 is omitted here for brevity. The driver 612 for generating driving signals to control movement of the lens included in the optical pickup head 604 according to the servo output signal, including a tracking servo output TRO and/or a focus servo output FOO. Due to the adjusted defect signal (i.e., the output signal S_OUT), the servo control circuit 610 is therefore protected from applying inappropriate servo control effort to the optical pickup head 604. As mentioned above, the exemplary signal processing device 300 determines the beginning and end of one full rotation of the optical storage medium 502 according to the frequency generator signal FG to identify a current position of the optical pickup head 604 on the optical storage medium 502; however, this is for illustrative purposes only. In an alternative design, the current position of the optical pickup head 604 on the optical storage medium 502 can also be obtained by a wobble signal derived from a wobble track on the optical storage medium 502 or a data signal (e.g., eight-to-fourteen modulation data) derived from a data track on the optical storage medium 502.

Briefly summarized, during a current full rotation of an optical storage medium, defect information (e.g., counter values) of defective areas on the optical storage medium is recorded, and an adjusted defect signal is generated by adjusting the defect signal according to defect information (e.g., counter values) of defective areas that is recorded during a previous full rotation of the optical storage medium.

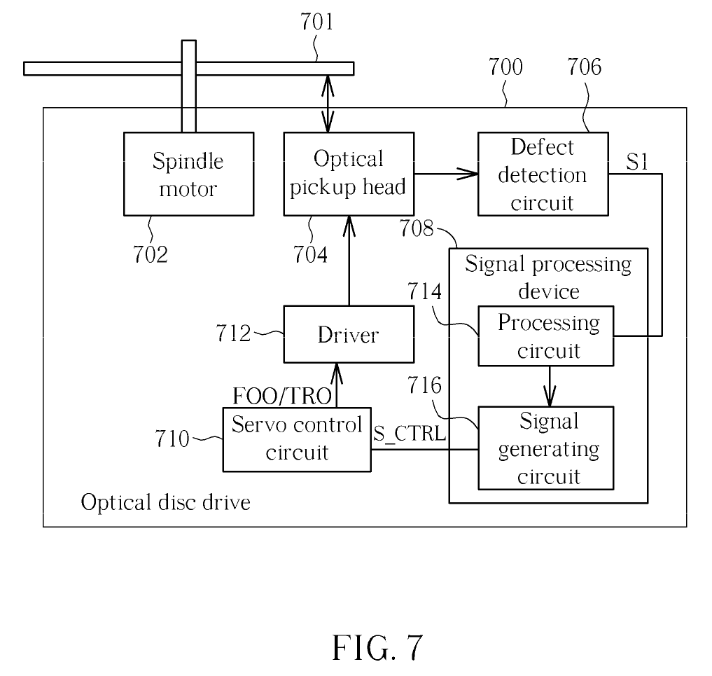

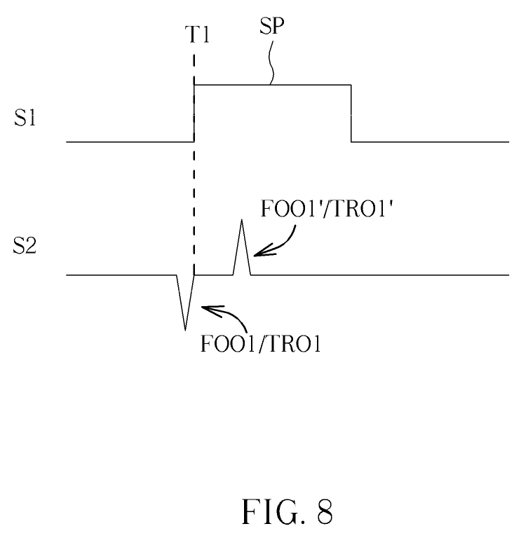

As described in above paragraphs, the inappropriate servo control effort is eliminated or mitigated with the help of the adjusted defect signal (e.g., the output signal S_OUT). In another exemplary embodiment of the present invention, a feedforward control mechanism applied to the servo control is proposed. Please refer to FIG. 7, which is a block diagram illustrating an optical disc drive 700 with a feedforward control mechanism implemented therein. The optical disc drive 700 includes a spindle motor 702 for rotating an optical storage medium (e.g., an optical disc) 701 at a target rotational speed, an optical pickup head 704 for emitting a laser beam to access the optical storage medium 701, a defect detection circuit 706 for generating a defect signal S1, a signal processing device 708 having a processing circuit 714 and a signal generating circuit 716, a driver 712 for generating driving signals to control the lens in the optical pickup head 704 according to a servo output signal, including a tracking servo output TRO and/or a focus servo output FOO, and a servo control circuit 710 for generating the servo output signal. In this exemplary embodiment, the processing circuit 714 is implemented for detecting a starting point of a signal portion, which is indicative of a corresponding defective area on the optical storage medium 701 and included in the defect signal S1, and estimating an amount of latest servo control effort applied before the starting point of the detected signal portion. FIG. 8 is a waveform diagram of a defect signal S1 and a servo output signal (e.g., a tracking servo output TRO or focus servo output FOO) S2. At time T1, the processing circuit 714 detects a starting point (e.g., a rising edge) of a signal portion SP, which is indicative of a corresponding defective area on the optical storage medium 701 and included in the defect signal S1, and estimates the amount of latest servo control effort FOO1/TRO1 (i.e., an inappropriate servo control effort) applied before the starting point of the detected signal portion SP. Next, the signal generating circuit 716, which is coupled to the processing circuit 714, generates a control signal S_CTRL to control the servo control circuit 710 to compensate for the amount of latest servo control effort FOO1/TRO1 applied before the starting point of the detected signal portion SP. As shown in FIG. 8, in accordance with the control signal S_CTRL generated due to the estimated amount of latest servo control effort FOO1 /TRO1, the servo control circuit 710 applies an inverse servo control effort FOO1′/TRO1′ after the starting point of the detected signal portion SP. That is, the inverse servo control effort FOO1′ /TRO1′ is applied when the optical pickup head 704 is currently accessing a defective area indicated by the corresponding signal portion SP. In this way, the inappropriate servo control effort FOO1/TRO1 can be cancelled or mitigated by the inverse servo control effort FOO1′/TRO1′.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal processing device, comprising:
a processing circuit, for determining a position of at least one defective area on an optical storage medium according to a defect signal and accordingly recording defect position information of the at least one defective area; and
a signal generating circuit, coupled to the processing circuit, for generating an output signal according to at least the recorded defect position information of the at least one defective area.

2. The signal processing device of claim 1, wherein the processing circuit obtains the position of the at least one defective area on the optical storage medium according to a frequency generator (FG) signal generated in response to a spindle rotation, a wobble signal derived from a wobble track on the optical storage medium, a data signal derived from a data track on the optical storage medium, or a clock signal with a predetermined clock frequency.

3. The signal processing device of claim 1, wherein the signal generating circuit generates the output signal by adjusting the defect signal according to the recorded defect position information of the at least one defective area.

4. The signal processing device of claim 1, wherein the processing circuit comprises:
a comparing unit, for comparing a width of a specific signal portion included in the defect signal with a predetermined threshold value, wherein the specific signal portion is indicative of a corresponding defective area on the optical storage medium; and
a defect position information recording unit, coupled to the comparing unit, wherein when the comparing unit detects that the width of the specific signal portion substantially reaches the predetermined threshold value, the defect position information recording unit records defect position information of the corresponding defective area according to a position of the corresponding defective area on the optical storage medium.

5. The signal processing device of claim 1, wherein the processing circuit comprises:
a counter, for counting each full rotation of the optical storage medium to generate a counter value indicative of a corresponding position on the optical storage medium; and
a storage, for recording the defect position information of the at least one defective area by storing a counter value corresponding to the at least one defective area.

6. The signal processing device of claim 5, wherein the counter is reset to an initial value after each full rotation of the optical storage medium, and the signal generating circuit comprises:
an adjusting unit, for adjusting the stored counter value corresponding to the at least one defective area by at least a first adjustment value to generate at least a first adjusted counter value; and
a comparing unit, coupled to the counter and the adjusting unit, for comparing the counter value currently counted by the counter with at least the first adjusted counter value; and
a signal generating unit, coupled to the comparing unit, for generating a specific signal according to a comparison result generated from the comparing unit, and outputting the output signal according to at least the specific signal.

7. The signal processing device of claim 6, wherein the adjusting unit subtracts the first adjustment value from the stored counter value corresponding to the at least one defective area to generate the first adjusted counter value, and adds a second adjustment value to the stored counter value corresponding to the at least one defective area to generate a second adjusted counter value; the comparing unit compares the counter value counted by the counter with the first adjusted counter value and the second adjusted counter value, respectively; and the signal generating unit makes the specific signal have a level transition from a first logic level to a second logic level when the counter value currently counted by the counter substantially reaches the first adjusted counter value, and makes the specific signal have a level transition from the second logic level to the first logic level when the counter value currently counted by the counter substantially reaches the second adjusted counter value.

8. The signal processing device of claim 6, wherein the signal generating unit generates the output signal by performing an OR logic operation upon the specific signal and the defect signal.

9. A signal processing device, comprising:
a processing circuit, for recording defect information of at least one defective area on an optical storage medium according to a defect signal derived during a first full rotation of the optical storage medium; and
a signal generating circuit, coupled to the processing circuit, for generating an adjusted defect signal by adjusting the defect signal derived during a second full rotation of the optical storage medium according to the recorded defect information of the at least one defective area.

10. The signal processing device of claim 9, wherein the processing circuit determines a position of the at least one defective area on the optical storage medium according to the defect signal derived during the first full rotation of the optical storage medium, and records defect position information of the at least one defective area as the defect information of the at least one defective area.

11. The signal processing device of claim 9, wherein the signal generating circuit generates the adjusted defect signal by advancing a starting point of a signal portion, which is indicative of a corresponding defective area on the optical storage medium and included in the defect signal derived during the second full rotation of the optical storage medium, according to the recorded defect information of the at least one defective area.

12. A signal processing device, comprising:
a processing circuit, for detecting a starting point of a signal portion, which is indicative of a corresponding defective area on an optical storage medium and included in a defect signal, and when the starting point of the signal portion is detected, estimating an amount of latest servo control effort applied before the starting point of the signal portion; and
a signal generating circuit, coupled to the processing circuit, for controlling a servo control circuit to compensate for the amount of latest servo control effort applied before the starting point of the signal portion.

13. A signal processing method, comprising:
determining a position of at least one defective area on an optical storage medium according to a defect signal;
recording defect position information of the at least one defective area; and
generating an output signal according to at least the recorded defect position information of the at least one defective area.

14. The signal processing method of claim 13, wherein the position of the at least one defective area on the optical storage medium is obtained according to a frequency generator (FG) signal generated in response to a spindle rotation, a wobble signal derived from a wobble track on the optical storage medium, a data signal derived from a data track on the optical storage medium or a clock signal with a predetermined clock frequency.

15. The signal processing method of claim 13, wherein the step of generating the output signal comprises:
generating the output signal by adjusting the defect signal according to the recorded defect position information of the at least one defective area.

16. The signal processing method of claim 13, wherein the step of recording the
defect position information of the at least one defective area comprises:
comparing a width of a specific signal portion included in the defect signal with a predetermined threshold value, wherein the specific signal portion is indicative of a corresponding defective area on the optical storage medium; and
when the width of the specific signal portion is detected to substantially reach the predetermined threshold value, recording defect position information of the corresponding defective area according to a position of the corresponding defective area on the optical storage medium.

17. The signal processing method of claim 13, wherein the step of recording the defect position information of the at least one defect comprises:
counting each full rotation of the optical storage medium to generate a
counter value indicative of a corresponding position on the optical storage medium; and
recording the defect position information of the at least one defective area by storing a counter value corresponding to the at least one defective area.

18. The signal processing method of claim 17, wherein the counter value is reset after each full rotation of the optical storage medium, and the step of generating the output signal comprises:
adjusting the stored counter value corresponding to the at least one defective area by at least a first adjustment value to generate at least a first adjusted counter value; and
comparing the counter value currently counted with at least the first adjusted counter value to generate a comparison result; and
generating a specific signal according to the comparison result, and outputting the output signal according to at least the specific signal.

19. A signal processing method, comprising:
recording defect information of at least one defective area on an optical storage medium according to a defect signal derived during a first full rotation of the optical storage medium; and
generating an adjusted defect signal by adjusting the defect signal derived during a second full rotation of the optical storage medium according to the recorded defect information of the at least one defective area.

20. The signal processing method of claim 19, wherein the step of recording the
defect information of the at least one defective area on the optical storage medium comprises:
determining a position of the at least one defective area on the optical storage medium according to the defect signal derived during the first full rotation of the optical storage medium; and
recording defect position information of the at least one defective area as the defect information of the at least one defective area.

21. The signal processing method of claim 19, wherein the step of generating the adjusted defect signal comprises:
generating the adjusted defect signal by advancing a starting point of a signal portion, which is indicative of a corresponding defective area on the optical storage medium and included in the defect signal derived during the second full rotation of the optical storage medium, according to the recorded defect information of the at least one defective area.

22. A signal processing method, comprising:
detecting a starting point of a signal portion, which is indicative of a corresponding defective area on an optical storage medium and included in a defect signal; and when the starting point of the signal portion is detected, estimating an amount of latest servo control effort applied before the starting point of the signal portion; and
controlling a servo control circuit to compensate for the amount of latest servo control effort applied before the starting point of the signal portion.
